(19) United States
(12) Patent Application Publication
(10) Pub. No.: US 2025/0355542 A1
(43) Pub. Date: Nov. 20, 2025

(54) INFORMATION PROCESSING METHOD, ELECTRONIC DEVICE, AND READABLE MEDIUM

(71) Applicant: DOUYIN VISION CO., LTD., Beijing (CN)

(72) Inventors: Xin WANG, Beijing (CN); Huijing NIE, Beijing (CN)

(21) Appl. No.: 19/063,578

(22) Filed: Feb. 26, 2025

(30) Foreign Application Priority Data
May 16, 2024 (CN) 202410613305.3

(51) Int. Cl. G06F 3/0483

(52) U.S. Cl. CPC G06F 3/0483

(57) ABSTRACT

The embodiments of the present disclosure provides an information processing method and apparatus, and a related product, where the method includes: displaying a reading page of a first e-book; displaying a dialogue page for dialoguing with a digital assistant in response to a trigger operation for the digital assistant on the reading page by a user; and displaying, in response to a first message sent by the user to the digital assistant on the dialogue page, a second message which is replied to the first message by the digital assistant based on a book type of the first e-book on the dialogue page, where the book type of the first e-book includes a serialized book or a finished book.

### CROSS-REFERENCE TO RELATED APPLICATION

This application claims the priority to and benefits of the Chinese Patent Application No. 202410613305.3, which was filed on May 16, 2024. The aforementioned patent application is hereby incorporated by reference in its entirety.

### TECHNICAL FIELD

The present disclosure relates to the field of computer technology, and in particular, to an information processing method and apparatus, and an associated product.

### BACKGROUND

At present, users often read e-books. For example, a reading application is in a mobile phone and e-books can be read in such reading application. When the users read e-books, different types of e-books always have different information obtaining requirements. Therefore, it is desirable to provide a technical solution to facilitate users to obtain the information they need and improve the reading efficiency of users reading e-books.

### SUMMARY

The embodiments of the present disclosure provide an information processing method and apparatus, and an associated product that can provide a user with information needed by the user according to a type of an e-book, improving efficiency of the user reading the e-book.

In a first aspect, an embodiment of the present disclosure provides an information processing method, including:
displaying a reading page of a first e-book;
displaying a dialogue page for dialoguing with a digital assistant in response to a trigger operation for the digital assistant on the reading page by a user; and
displaying, in response to a first message sent by the user to the digital assistant on the dialogue page, a second message which is replied to the first message by the digital assistant based on a book type of the first e-book on the dialogue page, wherein the book type of the first e-book includes a serialized book or a finished book.

In a second aspect, an embodiment of the present disclosure provides an information processing apparatus, including:
a first display unit configured to display a reading page of a first e-book;
a second display unit configured to display a dialogue page for dialoguing with a digital assistant in response to a trigger operation for the digital assistant on the reading page by a user; and
a third display unit configured to display, in response to a first message sent by the user to the digital assistant on the dialogue page, a second message which is replied to the first message by the digital assistant based on a book type of the first e-book on the dialogue page, wherein the book type of the first e-book includes a serialized book or a finished book.

In a third aspect, an embodiment of the present disclosure provides an electronic device, including a processor; and a memory configured to store a computer-executable instruction that, wherein the computer-executable instruction, when being executed, causes the processor to implement the steps of the method described in the first aspect.

In a fourth aspect, an embodiment of the present disclosure provides a computer-readable storage medium for storing a computer-executable instruction wherein the computer-executable instruction, when being executed by a processor, implements the steps of the method described in the first aspect.

In a fifth aspect, an embodiment of the present disclosure provides a computer program product including a computer program which, when being executed by a processor, implements the steps of the method described in the first aspect.

### BRIEF DESCRIPTION OF DRAWINGS

In order to explain one or more embodiments of the present disclosure or the technical scheme in the prior art more clearly, the drawings needed in the description of the embodiments or the prior art will be briefly introduced below. Obviously, the drawings in the following description are only some of the embodiments recorded in this disclosure, and other drawings can be obtained according to these drawings for ordinary people in the field without creative labor.

FIG. 1 is a flow chart of an information processing method provided in an embodiment of the present disclosure;

FIG. 2 is a schematic diagram of a reading page of a first e-book provided in an embodiment of the present disclosure;

FIG. 3 is a schematic diagram of a dialogue page provided in an embodiment of the present disclosure;

FIG. 4 is a schematic diagram of a dialogue page provided in another embodiment of the present disclosure;

FIG. 5 is a schematic diagram of a dialogue page provided in another embodiment of the present disclosure;

FIG. 6 is a schematic diagram of a dialogue page provided in another embodiment of the present disclosure;

FIG. 7 is a schematic diagram of a dialogue page provided in another embodiment of the present disclosure;

FIG. 8 is a schematic diagram of a dialogue page provided in another embodiment of the present disclosure;

FIG. 9 is a structural schematic diagram of an information processing apparatus provided in an embodiment of the present disclosure; and

FIG. 10 is a structural schematic diagram of an electronic device provided in an embodiment of the present disclosure.

### DETAILED DESCRIPTION

In order to make people in the technical field better understand the technical scheme in one or more embodiments of the present disclosure, the technical scheme in one or more embodiments of the present disclosure will be described clearly and completely with the accompanying drawings. Obviously, the described embodiments are only part of the embodiments of the present disclosure, but not all of them. Base on one or more embodiments of that present disclosure, all other embodiment obtained by those skilled in the art without creative labor should belong to the protection scope of the present disclosure.

It may be appreciated that before using the technical solutions disclosed in the embodiments of the present disclosure, the types, scope of use, use scenarios, and the like of the personal information involved in the present disclosure shall be informed to users and authorization shall be obtained from the users through appropriate methods in accordance with relevant laws and regulations.

For example, in response to receiving an active request from a user, prompt information is sent to the user to explicitly inform the user that the action requested by the user requires obtaining and use of personal information of the user. As such, the user can independently choose whether to provide personal information to a software or a hardware such as an electronic device, an application, a server or a storage media that perform the operation of the technical scheme of the present disclosure according to the prompt information.

As an optional but non-limited implementation, in response to receiving the active request from the user, the prompt information may be sent to the user by means of, for example, a pop-up window, which may present the prompt information in the form of text. In addition, the pop-up window may also carry a selection control for the user to choose whether to “agree” or “disagree” to provide personal information to the electronic device.

It may be understood that the foregoing process of notifying the user and obtaining authorization from the user are only illustrative and do not limit implementations of the present disclosure, and other means that meet relevant laws and regulations may also be applied to the implementation the present disclosure.

The embodiments of the present disclosure provide a method for processing information that is capable of providing a user with information needed by the user according to a type of an e-book, improving efficiency of the user reading the e-book. The method for processing information in the embodiments of the present disclosure may be applied to and executed by a terminal device, wherein the terminal device includes but is not limited to an electronic device such as a mobile phone, a computer, a tablet, a laptop, a vehicle-mounted computer, a wearable device, and a VR (Virtual Reality) device.

FIG. 1 is a schematic flow chart of an information processing method provided in an embodiment of the present disclosure. As shown in FIG. 1, the process includes the following steps:
S102: displaying a reading page of a first e-book;
S104: displaying a dialogue page for dialoguing with a digital assistant in response to a trigger operation for the digital assistant on the reading page by a user;
S106: displaying, in response to a first message sent by the user to the digital assistant on the dialogue page, a second message which is replied to the first message by the digital assistant based on a book type of the first e-book on the dialogue page, wherein the book type of the first e-book includes a serialized book or a finished book.

In this embodiment, firstly, a reading page of a first e-book is displayed, then a dialogue page for dialoguing with a digital assistant is display in response to a trigger operation for the digital assistant on the reading page by a user, and finally, a second message which is replied to the first message by the digital assistant based on a book type of the first e-book on the dialogue page is displayed in response to a first message sent by the user to the digital assistant on the dialogue page, wherein the book type of the first e-book includes a serialized book or a finished book. It can be seen that through this embodiment, the user can interact with the digital assistant, and the digital assistant can reply the second message according to the first message sent by the user and the book type of the first e-book, so as to provide the user with the information needed by the user according to the book type of the e-book and improve the reading efficiency of the user reading the e-book.

In the above step S102, the reading page of the first e-book is displayed. In an embodiment, the reading page of the first e-book may be displayed in the terminal device in response to a reading operation for the first e-book from the user. For example, the reading page of the first e-book may be displayed in a reading application installed in the terminal device in response to the reading operation for the first e-book in the reading application from the user. The first e-book may be an e-book of any type, which is not limited herein. The reading page of the first e-book may be any page of the first e-book, or the page of the first e-book where the user left in the previous reading. In this embodiment, each operation where the user opens the first e-book may be regarded as a reading operation of the user for the first e-book, thereby determining the page where the user left in the previous reading as the reading page.

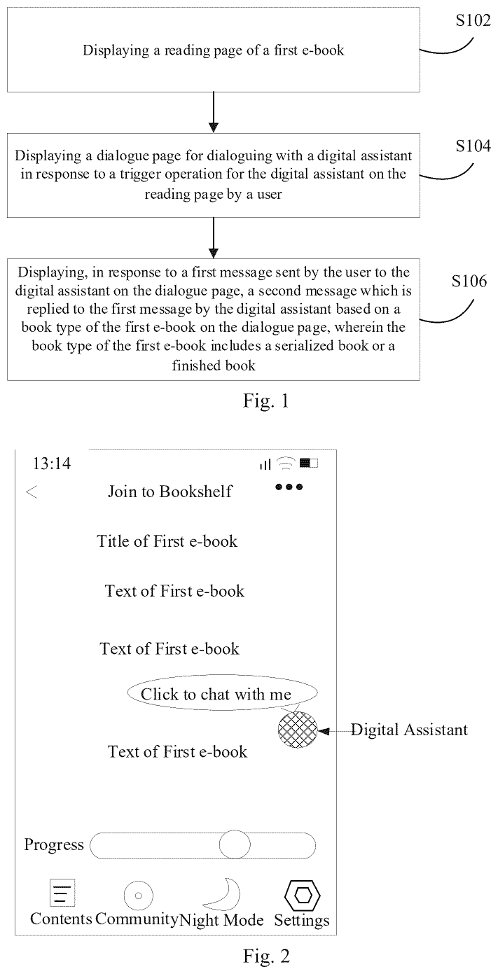

FIG. 2 is a schematic diagram of the reading page of the first e-book provided in an embodiment of the present disclosure. As shown in FIG. 2, the reading page of the first e-book may be displayed on the terminal device, and FIG. 2 shows an example where the reading page is the page where the user left in the previous reading.

In the above step S104, in response to the trigger operation for the digital assistant on the reading page from the user, the dialogue page for dialoguing with a digital assistant is displayed. In this embodiment, a digital assistant is displayed on the reading page of the first e-book, where the digital assistant may be a chat robot generated based on a large language model, and the user may trigger the digital assistant by for example clicking on the digital assistant. Based on this, in response to a trigger operation for the digital assistant on the reading page from the user, a dialogue page for dialoguing with a digital assistant is displayed. In this embodiment, the digital assistant may be a digital assistant corresponding to a character in the first e-book, or a digital assistant corresponding to the first e-book.

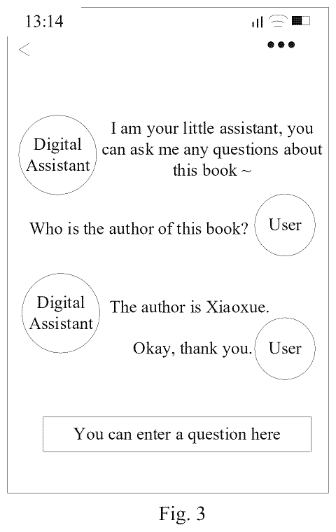

As shown in FIG. 2, the digital assistant is displayed on the reading page, as shown by the circle in FIG. 2. The digital assistant is also configured with a prompt, such as “Click to chat with me”. By triggering the digital assistant, the user may jump to the dialogue page and chat with the digital assistant on the dialogue page. FIG. 3 is a schematic diagram of a dialogue page provided in an embodiment of the present disclosure. As shown in FIG. 3, a user may chat with a digital assistant on the dialogue page and obtain the required information.

In the foregoing step S106, in response to a first message sent by the user to the digital assistant on the dialogue page, a second message that the digital assistant replies to the first message based on a book type of the first e-book is displayed on the dialogue page, where the book type of the first e-book includes a serialized book or a finished book.

In this embodiment, the user may send the first message to the digital assistant on the dialogue page through one or more of voice input, text input, and selection options. The digital assistant generates the second message for the first message based on the book type of the first e-book, and the terminal device may display the second message on the dialogue page, thereby providing the user with the information required by the user based on the book type of the e-book, and improving efficiency of the user in reading the e-book.

In an embodiment, the book type of the first e-book includes a serialized book, and the reading page of the first e-book includes a most recently updated content page of the first e-book, and displaying the dialogue page for dialoguing with the digital assistant in response to the trigger operation for the digital assistant on the reading page by the user includes:
displaying a dialogue page for dialoguing with a digital assistant corresponding to a character in the first e-book in response to a trigger operation for the digital assistant corresponding to the character on the reading page from the user, wherein the character includes a character that has already appeared in the first e-book or a character that is expected to appear in the first e-book.

In this embodiment, the reading page of the first e-book includes the most recently updated content page of the first e-book. For example, the reading page of the first e-book is the last page of the most recently updated chapter of the first e-book. Since the reading page includes the most recently updated content page of the first e-book, it may be assumed that the user has read all the updated content of the first e-book. In this case, the digital assistant is displayed on the reading page of the first e-book, where the digital assistant may be a digital assistant corresponding to a character in the first e-book, that is, the digital assistant is configured to represent a character in the first e-book, and the chatting by the user with the digital assistant may be equivalent to chatting with the character in the book.

Since the first e-book is a serialized book, the character in the book may be a character that has already appeared in the chapters that have been updated in the first e-book, such as a popular character that has already appeared. In addition, considering that some popular characters may be in the chapters in the first e-book that have not yet been updated, the character in the book may also be a character that is expected to appear in the chapters of the first e-book to be updated in the future, such as a popular character expected to appear. The popular characters in the first e-book may be identified based on review information on the first e-book from the author.

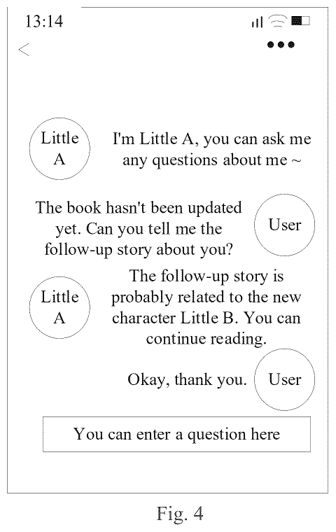

Based on this, in response to the trigger operation for the digital assistant corresponding to the character in the first e-book on the reading page from the user, the dialogue page for dialoguing with a digital assistant corresponding to the character in the book is displayed. FIG. 4 is a schematic diagram of a dialogue page provided in another embodiment of the present disclosure. As shown in FIG. 4, as an example, with a character Little A that has appeared in the first e-book and the last page of the recently updated chapter of the first e-book, in response to the trigger operation on the reading page for the digital assistant corresponding to Little A, the dialogue page for dialoguing with a digital assistant corresponding to Little A is displayed, where on the dialogue page, the user may chat with the digital assistant corresponding to Little A to obtain the required information.

It may be seen that through the present embodiment, in response to that the first e-book is a serialized book and the user has read all the updated content, the digital assistant corresponding to the character in the first e-book may be configured on the reading page, and in response to the trigger operation for the digital assistant from the user, the user may be directed to the dialogue page for dialoguing with a digital assistant, such that the user may quickly obtain the required information through chatting with the digital assistant corresponding to the character in the book.

In an embodiment, the book type of the first e-book includes the serialized book, and the reading page of the first e-book includes a most recently updated content page of the first e-book, and displaying, in response to the first message sent by the user to the digital assistant on the dialogue page, the second message which is replied to the first message by the digital assistant based on the book type of the first e-book on the dialogue page includes:
displaying a possible plot development message for a character in the first e-book that the digital assistant replies on the dialogue page in response to a plot-related question sent by the user to the digital assistant on the dialogue page for the character in the first e-book.

In this embodiment, the reading page of the first e-book includes the most recently updated content page of the first e-book. For example, the reading page of the first e-book is the last page of the most recently updated chapter of the first e-book. Since the reading page includes the most recently updated content page of the first e-book, it may be assumed that the user has read all the updated content of the first e-book. In this case, the user may send a plot-related question for the character in the first e-book to the digital assistant on the dialogue page, and with the plot-related question as the first message, the digital assistant may generate a possible plot development message for the character in the chapters to be updated in the future, and display such a possible plot development message as the second message on the dialogue page, so that the user may obtain the possible plot development message of the character in the future chapters of the book.

In the above process, the user can input a plot-related question through voice input, text input, a selection option, and the like, and the digital assistant may be the digital assistant corresponding to the character in the book. The digital assistant may generate a possible plot development message for the character in future chapters according to a story outline written in advance by the author of the first e-book. The character in the book includes a character that has already appeared in the first e-book or a character that is expected to appear in the first e-book.

As shown in FIG. 4, with the character Little A who has appeared in the first e-book as an example, the user may chat with the digital assistant corresponding to Little A on the dialogue page to obtain a possible plot development message for the character Little A in future chapters. In this scenario, the user may chat with the digital assistant corresponding to the character in the book to obtain the possible plot development message for the character in the book.

It may be seen that through the present embodiment, in response to that the first e-book is a serialized book and the user has read all the updated content, the user may trigger the digital assistant in the most recently updated content page of the first e-book, and obtain the possible plot development message for the character in the book by chatting with the digital assistant, so as to understand the general storyline of the character in the book in advance.

In an embodiment, the book type of the first e-book includes the finished book, and the reading page of the first e-book includes an ending page of the first e-book, and displaying the dialogue page for dialoguing with the digital assistant in response to the trigger operation for the digital assistant on the reading page by the user includes:
displaying a dialogue page for dialoguing with a digital assistant corresponding to the first e-book in response to a trigger operation for the digital assistant corresponding to the first e-book on the reading page by the user.

In this embodiment, the reading page of the first e-book includes the ending page of the first e-book. For example, the reading page of the first e-book is the last page of the last chapter of the first e-book. Since the reading page includes the ending page of the first e-book, it may be assumed that the user has read all content of the first e-book. In this case, the digital assistant is displayed on the reading page of the first e-book, where the digital assistant may be a digital assistant corresponding to the first e-book, that is, the digital assistant is configured to represent the first e-book, and the chatting by the user with the digital assistant may be equivalent to chatting with the first e-book.

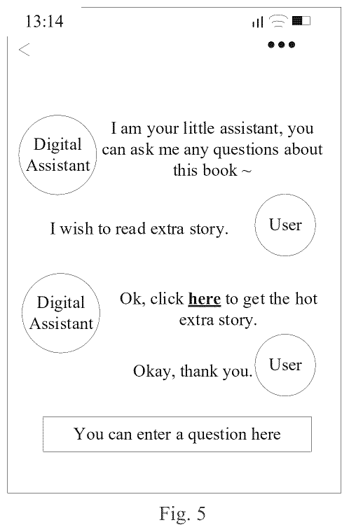

Based on this, in response to the trigger operation for the digital assistant corresponding to the first e-book on the reading page from the user, the dialogue page for dialoguing with a digital assistant corresponding to the first e-book is displayed. FIG. 5 is a schematic diagram of a dialogue page provided in another embodiment of the present disclosure. As shown in FIG. 5, after updating of the first e-book has finished and the user has read all content of the first e-book, in response to a trigger operation for a digital assistant corresponding to the first e-book on the ending page, the dialogue page for dialoguing with a digital assistant corresponding to the first e-book is displayed, where on the dialogue page, the user may chat with the digital assistant corresponding to the first e-book to obtain the required information.

It may be seen that through the present embodiment, in response to that the first e-book is a finished book and the user has read all content thereof, a digital assistant corresponding to the first e-book may be configured on the reading page, and in response to the trigger operation for the digital assistant from the user, the user may be directed to the dialogue page for dialoguing with a digital assistant, such that the user may quickly obtain the required information through chatting with the digital assistant corresponding to the first e-book.

In an embodiment, the book type of the first e-book includes the finished book, and the reading page of the first e-book includes an ending page of the first e-book, and displaying, in response to the first message sent by the user to the digital assistant on the dialogue page, the second message which is replied to the first message by the digital assistant based on the book type of the first e-book on the dialogue page includes:
displaying on the dialogue page at least one selected from the group consisting of a spin-off, a character biography, and a fan fiction related to the first e-book that the digital assistant replies in response to a request for more content for the first e-book sent by the user to the digital assistant on the dialogue page.

In this embodiment, the reading page of the first e-book includes the ending page of the first e-book. For example, the reading page of the first e-book is the last page of the last chapter of the first e-book. Since the reading page includes the ending page of the first e-book, it may be assumed that the user has read all content of the first e-book. In this case, the user may send a request for more content for the first e-book to the digital assistant on the dialogue page, and with the request for more content as the first message, the digital assistant may obtain one of a spin-off, a character biography, or a fan fiction related to the first e-book, a character biography, or a fan-article, generate a second message based on the obtained information, and display the second message on the dialogue page such that the user may obtain more content related to the first e-book.

In the above process, the user may input the request for more content through voice input, text input, a selection option, or the like, where the digital assistant may be a digital assistant corresponding to the first e-book, and the digital assistant corresponding to the first e-book may obtain at least one selected from the group consisting of a spin-off, a character biography, or a fan fiction related to the content related to the first e-book, and generate a second message according to the obtained information.

As shown in FIG. 5, after updating of the first e-book has completed and the user has read all the content of the first e-book, the user may chat with the digital assistant corresponding to the first e-book on the dialogue page to obtain at least one selected from the group consisting of a spin-off, a character biography, or a fan fiction related to the content related to the first e-book. In this scenario, the user may chat with the digital assistant corresponding to the first e-book to obtain more content of the first e-book.

It may be seen that through the present embodiment, in response to that the first e-book is a finished book and the user has read all the content, the user may trigger the digital assistant on the ending page of the first e-book, and obtain more content related to the first e-book by chatting with the digital assistant, improving reading experience of the user.

It may be apparent that in other embodiments, the book type of the first e-book includes a finished book, and the reading page includes the ending page of the first e-book, and the in response to a trigger operation for the digital assistant on the reading page from the user, displaying a dialogue page for dialoguing with a digital assistant includes: in response to the trigger operation for the digital assistant corresponding to a character in the first e-book on the reading page, displaying the dialogue page for dialoguing with a digital assistant corresponding to the character in the first e-book.

Correspondingly, in response to the first message sent by the user to the digital assistant on the dialogue page, displaying the second message that the digital assistant replies to the first message based on the book type of the first e-book on the dialogue page includes: in response to a request for more content for the first e-book sent by the user to the digital assistant corresponding to a character in the first e-book on the dialogue page, displaying on the dialogue page at least one selected from the group consisting of a spin-off, a character biography, or a fan fiction related to the first e-book that the digital assistant replies.

In this embodiment, in response to that the first e-book is a finished book and the user has read all the content, a digital assistant corresponding to the character in the first e-book may be displayed on the reading page, for example, a digital assistant corresponding to a popular character in the first e-book, and in response to that the user triggers the digital assistant, the user may be directed a dialogue page, where the user may send a request for more content for the first e-book to the digital assistant, and the digital assistant corresponding to the character in the first e-book obtains at least one selected from the group consisting of a spin-off, a character biography, or a fan fiction related to the first e-book, and replies it to the user, such that the user may obtain more content related to the first e-book, improving reading experience of the user. In this scenario, the user may chat with the digital assistant corresponding to the character in the book to obtain more content of the first e-book.

In an embodiment, the book type of the first e-book includes the finished book, and the reading page of the first e-book includes a content page other than the ending page of the first e-book, and displaying the dialogue page for dialoguing with the digital assistant in response to the trigger operation for the digital assistant on the reading page by the user includes:
displaying a dialogue page for dialoguing with a digital assistant corresponding to a character in the first e-book in response to a trigger operation for the digital assistant corresponding to the character on the reading page by the user, wherein the character includes a character that has already appeared before the reading page or a character that is expected to appear after the reading page.

In this embodiment, the reading page of the first e-book includes a content page other than the ending page of the first e-book, and the ending page may be the last page of the last chapter of the first e-book. Since the reading page includes a content page other than the ending page of the first e-book, it may be assumed that the user has not read all content of the first e-book. In this case, the digital assistant corresponding to the character in the first e-book is displayed on the reading page of the first e-book, and in response to the trigger operation for the digital assistant corresponding to the character in the first e-book on the reading page from the user, the dialogue page for dialoguing with a digital assistant corresponding to the character in the book is displayed.

The character in the book includes a character that has appeared before the reading page or a character that is expected to appear after the reading page. In other words, the character in the book may be a character that the user has already read about, or a character that the user has not yet read about.

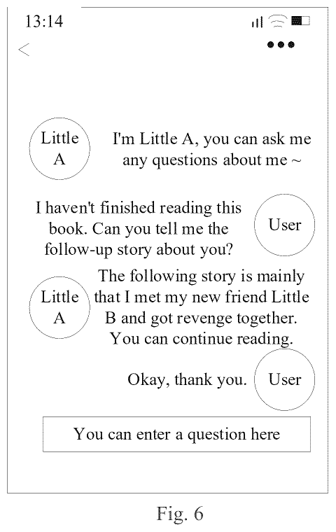

FIG. 6 is a schematic diagram of a dialogue page provided in another embodiment of the present disclosure. As shown in FIG. 6, after updating of the first e-book has finished and the user has not read all content of the first e-book, in response to a trigger operation for a digital assistant corresponding to a character in the first e-book on the reading page, the dialogue page for dialoguing with a digital assistant corresponding to the character in the first e-book is displayed, where on the dialogue page, the user may chat with the digital assistant corresponding to the character in the first e-book to obtain the required information.

It may be seen that through the present embodiment, in response to that the first e-book is a finished book and the user has not read all content, the digital assistant corresponding to the character in the first e-book may be configured on the reading page, and in response to the trigger operation for the digital assistant from the user, the user may be directed to the dialogue page for dialoguing with a digital assistant, such that the user may quickly obtain the required information through chatting with the digital assistant corresponding to the character in the first e-book.

In an embodiment, the book type of the first e-book includes the finished book, and the reading page of the first e-book includes a content page other than the ending page of the first e-book, and displaying, in response to the first message sent by the user to the digital assistant on the dialogue page, the second message which is replied to the first message by the digital assistant based on the book type of the first e-book on the dialogue page includes:
displaying on the dialogue page a plot development message for a character in the first e-book that the digital assistant replies in response to a plot-related question for the character in the first e-book sent by the user to the digital assistant on the dialogue page.

In this embodiment, the reading page of the first e-book includes a content page other than the ending page of the first e-book, and the ending page may be the last page of the last chapter of the first e-book. Since the reading page includes a content page other than the ending page of the first e-book, it may be assumed that the user has not read all content of the first e-book. In this case, the user may send a plot-related question for the character in the first e-book to the digital assistant on the dialogue page, and with the plot-related question as the first message, the digital assistant may generate an actual plot development message for the character in chapters that the user has not read, and display such actual plot development message as the second message on the dialogue page, such that the user may obtain the actual plot development message of the character in the chapters that the user has not read.

In the above process, the user can input a plot-related question through voice input, text input, a selection option, and the like, and the digital assistant may be the digital assistant corresponding to the character in the book. The digital assistant may generate an actual plot development message for the character according to content of the chapters in the first e-book that the user has not read. The character in the book includes a character that has appeared before the reading page or a character that is expected to appear after the reading page. In other words, the character in the book may be a character that the user has already read about, or a character that the user has not yet read about.

As shown in FIG. 6, with the character Little A who has appeared in the first e-book as an example, the user may chat with the digital assistant corresponding to Little A on the dialogue page to obtain an actual plot development message for the character Little A in future chapters. In the scenario shown in FIG. 6, the user may chat with the digital assistant corresponding to the character in the book to obtain the actual plot development message for the character in the book.

It may be seen that through the present embodiment, in response to that the first e-book is a finished book and the user has not read all content, the user may trigger the digital assistant on the reading page of the first e-book, and obtain the plot development message for the character in the book by chatting with the digital assistant, so as to understand the general storyline of the character in the book in advance.

It may be apparent that in other embodiments, the book type of the first e-book includes a serialized book, and the reading page includes a content page other than the most recently updated page of the first e-book, and the in response to a trigger operation for the digital assistant on the reading page from the user, displaying a dialogue page for dialoguing with a digital assistant includes: in response to the trigger operation for the digital assistant corresponding to a character in the first e-book on the reading page from the user, displaying the dialogue page for dialoguing with a digital assistant corresponding to the character in the book, where the character in the book includes a character that has appeared before the reading page or a character that is expected to appear after the reading page.

Correspondingly, in response to the first message sent by the user to the digital assistant on the dialogue page, displaying the second message that the digital assistant replies to the first message based on the book type of the first e-book on the dialogue page includes: in response to a plot-related question for the first e-book sent by the user to the digital assistant on the dialogue page, displaying on the dialogue page a plot development message for the character in the first e-book that the digital assistant replies.

In this embodiment, in response to that the first e-book is a serialized book and the user has not read all the updated content, a digital assistant corresponding to the character in the first e-book may be displayed on the reading page, for example, a digital assistant corresponding to a popular character in the first e-book, and in response to that the user triggers the digital assistant, the user may be directed a dialogue page, where the user may send a plot-related question for the character in the first e-book to the digital assistant, and the digital assistant corresponding to the character in the first e-book determines an actual plot development message for the character in the book according to content of chapters in the first e-book that the user has not read, such that the user may obtain further storyline information for the character in the book. In this scenario, the user may chat with the digital assistant corresponding to the character in the book to obtain the future storyline information for the character in the book.

In an embodiment, displaying, in response to the first message sent by the user to the digital assistant on the dialogue page, the second message which is replied to the first message by the digital assistant based on the book type of the first e-book on the dialogue page includes:
displaying, in response to the first message sent by the user to the digital assistant on the dialogue page, the second message that the digital assistant replies to the first message based on the book type of the first e-book and an engagement degree of the user for the first e-book on the dialogue page.

In this embodiment, the digital assistant may be a digital assistant corresponding to a character in the first e-book, or a digital assistant corresponding to the first e-book. The digital assistant may reply to the first message with the second message in response to the first message sent by the user, based on the book type of the first e-book and the engagement degree of the user for the first e-book. The engagement degree of the user for the first e-book is determined based on reading time that the user spends on the first e-book and/or the number of comments of the user on the first e-book.

It may be seen that through the present embodiment, the second message may also be replied to the user according to the book type of the first e-book and the engagement degree of the user for the first e-book, thereby accurately providing the user with the required information.

In an embodiment, the book type of the first e-book includes the serialized book, and the engagement degree of the user for the first e-book is greater than an engagement degree threshold, and displaying, in response to the first message sent by the user to the digital assistant on the dialogue page, the second message which is replied to the first message by the digital assistant based on the book type of the first e-book on the dialogue page includes:
displaying a plot-related discussion message that the digital assistant replies on the dialogue page in response to a plot recommendation for the first e-book sent by the user to the digital assistant on the dialogue page.

In this embodiment, in response to that the book type of the first e-book includes a serialized book, and the engagement degree of the user for the first e-book is greater than the engagement degree threshold, the user may send a first message to the digital assistant through various means such as text input, voice input, or a selection option, where the first message includes a story recommendation on the first e-book; and the digital assistant displays a second message on the dialogue page according to the story recommendation, where the second message includes a plot-related discussion message. For example, the user may discuss the story with the digital assistant, or the digital assistant sends to the user the plot-related discussion message for the first e-book from the creation team of the first e-book as the second message, such that the user may be deeply engaged in the story creation of the first e-book. In an embodiment, a story recommendation includes a story recommendation for a chapter of the first e-book that has not yet been updated, and a plot-related discussion message includes a plot-related discussion message for a chapter of the first e-book that has not yet been updated.

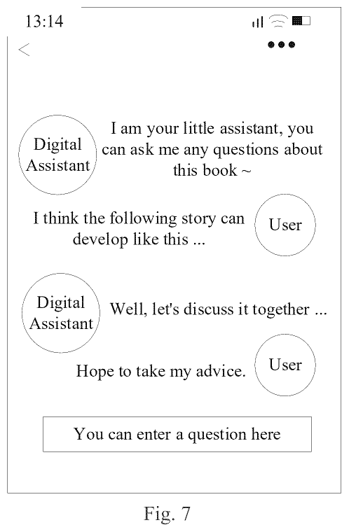

FIG. 7 is a schematic diagram of a dialogue page provided in another embodiment of the present disclosure. As shown in FIG. 7, for a serialized book, a deeply engaged user may discuss with a digital assistant on the storyline of a chapter of the first e-book that has not yet been updated.

It may be seen that through the present embodiment, for a serialized book, a deeply engaged user may discuss the storyline with the digital assistant for the first e-book, thereby improving experience of the user in reading the first e-book.

In an embodiment, the book type of the first e-book includes the finished book, and the engagement degree of the user for the first e-book is greater than an engagement degree threshold, and displaying, in response to the first message sent by the user to the digital assistant on the dialogue page, the second message which is replied to the first message by the digital assistant based on the book type of the first e-book on the dialogue page includes:
displaying more content that the digital assistant replies on the dialogue page in response to a request for generating more content for the first e-book sent by the user to the digital assistant on the dialogue page, wherein the more content is generated for a keyword in the request, and the more content includes at least one selected from the group consisting of a spin-off, a character biography, and a fan fiction related to the first e-book.

In this embodiment, in response to that the book type of the first e-book includes a finished book, and the engagement degree of the user for the first e-book is greater than the engagement degree threshold, the user may send a first message to the digital assistant through various means such as text input, voice input, or a selection option, where the first message includes a request for generating more content for the first e-book; and the digital assistant identifies a keyword in the request for generating more content, generates for the user more content related to the first e-book according to the keyword, and generates a second message according to the more content generated and displays the second message on the dialogue page. The keyword includes at least one selected from the group consisting of “spin-off”, “fan fiction”, and “character”, and the more content generated by the digital assistant includes at least one selected from the group consisting of a spin-off, a character biography, or a fan fiction related to the first e-book.

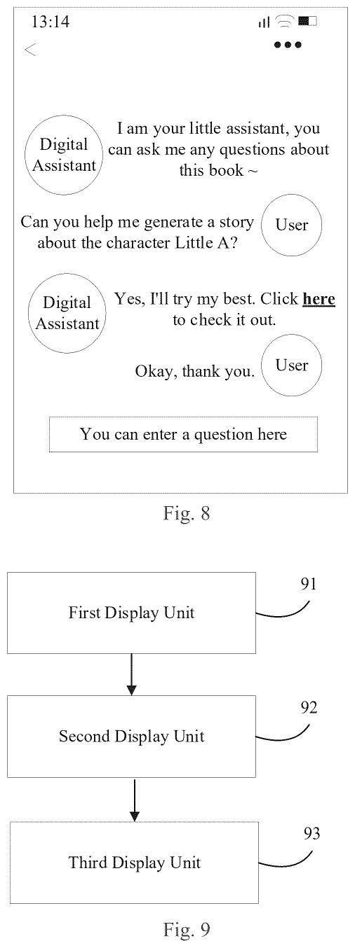

FIG. 8 is a schematic diagram of a dialogue page provided in another embodiment of the present disclosure. As shown in FIG. 8, for a finished book, a digital assistant may generate at least one selected from the group consisting of a spin-off, a character biography, or a fan fiction related to the first e-book for the deeply engaged user, meeting the demand of the user for further reading.

It may be seen that through the present embodiment, for the finished book, the digital assistant may generate at least one selected from the group consisting of a spin-off, a character biography, or a fan fiction related to the first e-book for the deeply engaged user, meeting the demand of the user for further reading.

To conclude, through the present embodiment, the user may interact with the digital assistant, and the digital assistant may reply to the first message with the second message according to the first message sent by the user based on the book type of the first e-book, thereby providing the user with the information required by the user based on the book type of the e-book, and improving efficiency of the user in reading the e-book.

FIG. 9 is a structural schematic diagram of an information processing apparatus provided in an embodiment of the present disclosure. As shown in FIG. 9, the apparatus includes:
a first display unit 91 configured to display a reading page of a first e-book;
a second display unit 92 configured to display a dialogue page for dialoguing with a digital assistant in response to a trigger operation for the digital assistant on the reading page by a user;
a third display unit 93 configured to display, in response to a first message sent by the user to the digital assistant on the dialogue page, a second message which is replied to the first message by the digital assistant based on a book type of the first e-book on the dialogue page, wherein the book type of the first e-book includes a serialized book or a finished book.

Optionally, the book type of the first e-book includes the serialized book; the reading page includes a most recently updated content page of the first e-book; and the second display unit 92 is specifically configured to:
display a dialogue page for dialoguing with a digital assistant corresponding to a character in the first e-book in response to a trigger operation for the digital assistant corresponding to the character on the reading page from the user, wherein the character includes a character that has already appeared in the first e-book or a character that is expected to appear in the first e-book.

Optionally, the book type of the first e-book includes the finished book; the reading page includes an ending page of the first e-book; and the second display unit 92 is specifically configured to:
display a dialogue page for dialoguing with a digital assistant corresponding to the first e-book in response to a trigger operation for the digital assistant corresponding to the first e-book on the reading page by the user.

Optionally, the book type of the first e-book includes the finished book; the reading page includes a content page other than an ending page of the first e-book; and the second display unit 92 is specifically configured to:
display a dialogue page for dialoguing with a digital assistant corresponding to a character in the first e-book in response to a trigger operation for the digital assistant corresponding to the character on the reading page by the user, wherein the character includes a character that has already appeared before the reading page or a character that is expected to appear after the reading page.

Optionally, the book type of the first e-book includes the serialized book; the reading page includes a most recently updated content page of the first e-book; and the third display unit 93 is specifically configured to:
display a possible plot development message for a character in the first e-book that the digital assistant replies on the dialogue page in response to a plot-related question sent by the user to the digital assistant on the dialogue page for the character in the first e-book.

Optionally, the book type of the first e-book includes the finished book; the reading page includes an ending page of the first e-book; and the third display unit 93 is specifically configured to:
display on the dialogue page at least one selected from the group consisting of a spin-off, a character biography, and a fan fiction related to the first e-book that the digital assistant replies in response to a request for more content for the first e-book sent by the user to the digital assistant on the dialogue page.

Optionally, the book type of the first e-book includes the finished book; the reading page includes a content page other than an ending page of the first e-book; and the third display unit 93 is specifically configured to:
display on the dialogue page a plot development message for a character in the first e-book that the digital assistant replies in response to a plot-related question for the character in the first e-book sent by the user to the digital assistant on the dialogue page.

Optionally, the third display unit 93 is specifically configured to:
display, in response to the first message sent by the user to the digital assistant on the dialogue page, the second message that the digital assistant replies to the first message based on the book type of the first e-book and an engagement degree of the user for the first e-book on the dialogue page.

Optionally, the book type of the first e-book includes the serialized book; the engagement degree of the user for the first e-book is greater than an engagement degree threshold; and the third display unit 93 is specifically configured to:
display a plot-related discussion message that the digital assistant replies on the dialogue page in response to a plot recommendation for the first e-book sent by the user to the digital assistant on the dialogue page.

Optionally, the book type of the first e-book includes the finished book; the engagement degree of the user for the first e-book is greater than an engagement degree threshold; and the third display unit 93 is specifically configured to:
display more content that the digital assistant replies on the dialogue page in response to a request for generating more content for the first e-book sent by the user to the digital assistant on the dialogue page, wherein the more content is generated for a keyword in the request, and the more content includes at least one selected from the group consisting of a spin-off, a character biography, and a fan fiction related to the first e-book.

The information processing apparatus in the embodiments of the present disclosure may implement individual processes of the embodiments of the information processing method and achieve the same effects and functions, which will not be described again here.

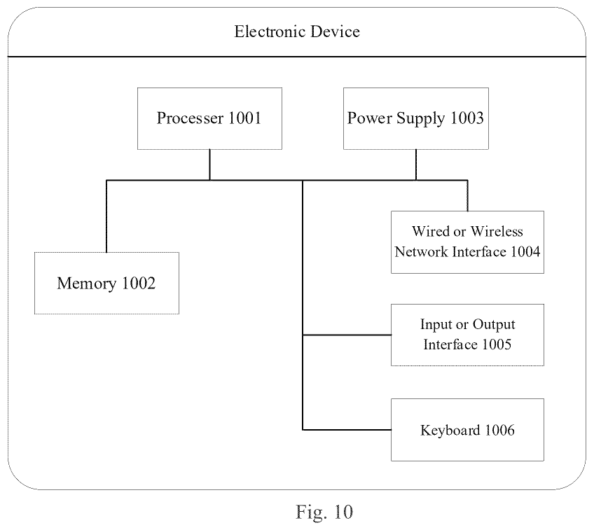

An embodiment of the present disclosure further provides an electronic device, and FIG. 10 is a structural schematic diagram of the electronic device provided in an embodiment of the present disclosure. As shown in FIG. 10, the electronic device may vary due to different configurations or performance, where it may include one or more processors 1001 or memories 1002, and may store one or more applications or data in the memory 1002. The memory 1002 may be a transient memory or a persistent memory. An application stored in the memory 1002 may include one or more modules (not shown), and each module may include a series of computer-executable instructions in the electronic device. Furthermore, the processor 1001 may be configured to communicate with the memory 1002 to execute a series of computer-executable instructions in the memory 1002 on the electronic device. The electronic device may also include one or more power supplies 1003, one or more wired or wireless network interfaces 1004, one or more input or output interfaces 1005, one or more keyboards 1006, or the like.

In a specific embodiment, the electronic device includes a processor; and a memory configured to store a computer-executable instruction, which, when being executed, causes the processor to implement the following processes:
display a reading page of a first e-book;
display a dialogue page for dialoguing with a digital assistant in response to a trigger operation for the digital assistant on the reading page by a user;
display, in response to a first message sent by the user to the digital assistant on the dialogue page, a second message which is replied to the first message by the digital assistant based on a book type of the first e-book on the dialogue page, wherein the book type of the first e-book includes a serialized book or a finished book.

The electronic device in the embodiments of the present disclosure may implement individual processes of the embodiments of the information processing method and achieve the same effects and functions, which will not be described again here.

Another embodiment of the present disclosure further provides a computer-readable storage medium with a computer-executed instruction stored thereon, where the computer-executed instruction, when being executed by a processor, implements the following processes:
display a reading page of a first e-book;
display a dialogue page for dialoguing with a digital assistant in response to a trigger operation for the digital assistant on the reading page by a user;
display, in response to a first message sent by the user to the digital assistant on the dialogue page, a second message which is replied to the first message by the digital assistant based on a book type of the first e-book on the dialogue page, wherein the book type of the first e-book includes a serialized book or a finished book.

The storage medium in the embodiments of the present disclosure may implement individual processes of the embodiments of the information processing method and achieve the same effects and functions, which will not be described again here.

Another embodiment of the present disclosure further provides a computer program product including a computer program, wherein the computer program, when being executed by a processor, implements the following processes:
display a reading page of a first e-book;
display a dialogue page for dialoguing with a digital assistant in response to a trigger operation for the digital assistant on the reading page by a user;
display, in response to a first message sent by the user to the digital assistant on the dialogue page, a second message which is replied to the first message by the digital assistant based on a book type of the first e-book on the dialogue page, wherein the book type of the first e-book includes a serialized book or a finished book.

The computer program product in the embodiments of the present disclosure may implement individual processes of the embodiments of the information processing method and achieve the same effects and functions, which will not be described again here.

In the embodiments of the present disclosure, the computer-readable storage medium includes a read-only memory (ROM), a random-access memory (RAM), a diskette or an optical disc, or the like.

In the 1990s, improvements to a technology could be clearly distinguished between hardware improvements (for example, improvements to circuit structures such as diodes, transistors, switches, or the like) and software improvements (improvements to method flows). However, with the technical developments, many of the current method flow improvements may be regarded as direct improvements in the hardware circuit structure. Designers almost always get a corresponding hardware circuit structure by programming an improved method flow into a hardware circuit. Therefore, improvements of a method flow may not be regarded as not be able to be implemented with a physical hardware module. For example, a programmable logic device (PLD) (for example, a field programmable gate array (FPGA)) is one of such integrated circuit whose logic function is determined by the device programming by a user. The designer may by itself program a digital system to “integrate” it on a PLD, without the need for a chip manufacturer to design and manufacture a dedicated integrated circuit chip. In addition, at present, instead of manually making an integrated circuit chip, such programming is mostly implemented by using “a logic compiler” software, which is similar to a software compiler used in program development and writing, and an original code before compilation must also be written in a specific programming language, which is herein referred to as a hardware description language (HDL), where there is not only one, but many such HDL, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language), or the like, and the VHDL (Very-High-Speed Integrated Circuit Hardware Description Language) and Verilog are the most commonly used. Those skilled in the art should also know that the hardware circuit that implements the logic method flow may be easily obtained by simply programming the method flow with the above-mentioned hardware description languages and programming it into the integrated circuit.

The controller may be embodied through any appropriate means. For example, the controller may take the form of, for example, a microprocessor or a processor and a computer-readable medium storing a computer-readable program code (such as software or firmware) that may be executed by the (micro) processor, a logic gate, a switch, an application-specific integrated circuit (ASIC), a programmable logic controller, and an embedded microcontroller. An example of the controllers includes, but is not limited to, the following microcontrollers: ARC 625D, Atmel AT91SAM, Microchip PIC18F26K20, and Silicone Labs C8051F320, and the memory controller may also be implemented as part of the memory control logic. Those skilled in the art may also understand that in addition to implementing the controller in the form of a pure computer-readable program code, it is completely possible to allow the controller to implement a same function in the form of a logic gate, a switch, an application-specific integrated circuit, a programmable logic controller, an embedded microcontroller, or the like by logically programming the method steps. Therefore, such a controller may be considered as a hardware component, and the means included therein configured to implement various functions may also be regarded as a structure within the hardware component. Or even, the means used to implement various functions may even be regarded as a software module that can be both a software module configured to implement a method and a structure within a hardware component.

The system, apparatus, module, or unit illustrated in the above embodiments may be embodied by a computer chip or entity, or by a product with a certain function. A typical implementation device is a computer. Specifically, the computer may be, for example, a personal computer, a laptop, a cellular phone, a camera phone, a smartphone, a personal digital assistant, a media player, a navigation device, an e-mail device, a gaming console, a tablet, a wearable device, or any combination thereof.

To facilitate description, the above device is divided into individual units by function and described separately. Of course, functions of the units may be implemented in the same software and/or hardware to implement the embodiments of the present disclosure.

It should be appreciated by those skilled in the art that one or more embodiments of the present disclosure may be embodied as a method, a system, or a computer program product. Accordingly, one or more embodiments of the present disclosure may be embodied in the form of a complete hardware embodiment, a complete software embodiment, or a combination of software and hardware embodiments. Furthermore, one or more embodiments of the present disclosure may be embodied in the form of a computer program product embodied on one or more computer-usable storage media (including but not limited to a disk memory, a CD-ROM, an optical memory, or the like) containing computer-usable program codes.

The present disclosure is described with reference to flow charts and/or block diagrams of a method, an apparatus (system), and a computer program product according to the embodiments of the present disclosure. It should be understood that each process and/or box in the flowcharts and/or block diagrams, as well as a combination of a process and/or box in the flowchart and/or block diagram, may be implemented by a computer program instruction. These computer program instructions may be provided to a processor of a general-purpose computer, a specialized computer, an embedded processing machine, or another programmable data processing device to generate a machine such that the instructions executed by the processor of the computer or another programmable data processing device generate a device for implementing the functions specified in one or more processes in the flow charts and/or one or more boxes in the block diagrams.

These computer program instructions may also be stored in a computer-readable memory capable of directing a computer or another programmable data-processing device to work in a particular manner such that the instructions stored in the computer-readable memory generate an article containing a directive device that implements the functions specified in one or more processes in the flowcharts and/or one or more boxes in the block diagrams.

These computer program instructions may also be loaded onto a computer or another programmable data processing device such that a series of operational steps are performed on the computer or another programmable device to generate a computer-implemented processing, such that the instructions executed on the computer or another programmable device provide steps for implementing the functions specified in one or more processes in the flowcharts and/or one or more boxes in the block diagrams.

It should also be noted that the terms “including”, “including” or any other variation thereof are intended to cover non-exclusive inclusion, so that a process, method, commodity or equipment including a series of elements includes not only those elements, but also other elements not explicitly listed, or elements inherent to such process, method, commodity or equipment. Without more restrictions, an element defined by the phrase “including one” does not exclude the existence of other identical elements in the process, method, commodity or equipment including the element.

One or more embodiment of that present disclosure may be described in the general context of computer-executable instruction, such as program modules, being executed by a compute. Generally, program modules include routines, programs, objects, components, data structures, etc. that perform particular tasks or implement particular abstract data types. One or more embodiments of the present disclosure may also be practiced in distributed computing environments where tasks are performed by remote processing devices that are connected through a communication network. In a distributed computing environment, program modules may be located in local and remote computer storage media including storage devices.

Each embodiment in this disclosure is described in a progressive way, and only the same and similar parts between the embodiments can be referred to each other, and each embodiment focuses on the differences from other embodiments. Especially, for the system embodiment, because it is basically similar to the method embodiment, the description is relatively simple, and the relevant points can only be found in part of the description of the method embodiment.

The above is only an example of the present disclosure, and is not used to limit the present disclosure. Various modifications and variations will occur to those skilled in the art. Any modification, equivalent substitution, improvement, etc. made within the spirit and principle of this disclosure should be included in the scope of the claims of this disclosure.

1. An information processing method, comprising:
displaying a reading page of a first e-book;
displaying a dialogue page for dialoguing with a digital assistant in response to a trigger operation for the digital assistant on the reading page by a user; and
displaying, in response to a first message sent by the user to the digital assistant on the dialogue page, a second message which is replied to the first message by the digital assistant based on a book type of the first e-book on the dialogue page, wherein the book type of the first e-book comprises a serialized book or a finished book.

2. The method according to claim 1, wherein the book type of the first e-book comprises the serialized book, and the reading page of the first e-book comprises a most recently updated content page of the first e-book, and displaying the dialogue page for dialoguing with the digital assistant in response to the trigger operation for the digital assistant on the reading page by the user comprises:
displaying a dialogue page for dialoguing with a digital assistant corresponding to a character in the first e-book in response to a trigger operation for the digital assistant corresponding to the character on the reading page from the user, wherein the character comprises a character that has already appeared in the first e-book or a character that is expected to appear in the first e-book.

3. The method according to claim 1, wherein the book type of the first e-book comprises the finished book, and the reading page comprises an ending page of the first e-book, and displaying the dialogue page for dialoguing with the digital assistant in response to the trigger operation for the digital assistant on the reading page by the user comprises:
displaying a dialogue page for dialoguing with a digital assistant corresponding to the first e-book in response to a trigger operation for the digital assistant corresponding to the first e-book on the reading page by the user.

4. The method according to claim 1, wherein the book type of the first e-book comprises the finished book; the reading page comprises a content page other than an ending page of the first e-book, and displaying the dialogue page for dialoguing with the digital assistant in response to the trigger operation for the digital assistant on the reading page by the user comprises:
displaying a dialogue page for dialoguing with a digital assistant corresponding to a character in the first e-book in response to a trigger operation for the digital assistant corresponding to the character on the reading page by the user, wherein the character comprises a character that has already appeared before the reading page or a character that is expected to appear after the reading page.

5. The method according to claim 1, wherein the book type of the first e-book comprises the serialized book, the reading page comprises a most recently updated content page of the first e-book, and displaying, in response to the first message sent by the user to the digital assistant on the dialogue page, the second message which is replied to the first message by the digital assistant based on the book type of the first e-book on the dialogue page comprises:
displaying a possible plot development message for a character in the first e-book that the digital assistant replies on the dialogue page in response to a plot-related question sent by the user to the digital assistant on the dialogue page for the character in the first e-book.

6. The method according to claim 1, wherein the book type of the first e-book comprises the finished book, the reading page comprises an ending page of the first e-book; and displaying, in response to the first message sent by the user to the digital assistant on the dialogue page, the second message which is replied to the first message by the digital assistant based on the book type of the first e-book on the dialogue page comprises:
displaying on the dialogue page at least one selected from the group consisting of a spin-off, a character biography, and a fan fiction related to the first e-book that the digital assistant replies in response to a request for more content for the first e-book sent by the user to the digital assistant on the dialogue page.

7. The method according to claim 1, wherein the book type of the first e-book comprises the finished book, the reading page comprises a content page other than an ending page of the first e-book, and displaying, in response to the first message sent by the user to the digital assistant on the dialogue page, the second message which is replied to the first message by the digital assistant based on the book type of the first e-book on the dialogue page comprises:
displaying on the dialogue page a plot development message for a character in the first e-book that the digital assistant replies in response to a plot-related question for the character in the first e-book sent by the user to the digital assistant on the dialogue page.

8. The method according to claim 1, wherein displaying, page in response to the first message sent by the user to the digital assistant on the dialogue page, the second message which is replied to the first message by the digital assistant based on the book type of the first e-book on the dialogue comprises:
displaying the second message that the digital assistant replies to the first message based on the book type of the first e-book and an engagement degree of the user for the first e-book on the dialogue page in response to the first message sent by the user to the digital assistant on the dialogue page.

9. The method according to claim 8, wherein the book type of the first e-book comprises the serialized book, the engagement degree of the user for the first e-book is greater than an engagement degree threshold, and displaying, in response to the first message sent by the user to the digital assistant on the dialogue page, the second message which is replied to the first message by the digital assistant based on the book type of the first e-book on the dialogue page comprises:
displaying a plot-related discussion message that the digital assistant replies on the dialogue page in response to a plot recommendation for the first e-book sent by the user to the digital assistant on the dialogue page.

10. The method according to claim 8, wherein the book type of the first e-book comprises the finished book, the engagement degree of the user for the first e-book is greater than an engagement degree threshold, and displaying, in response to the first message sent by the user to the digital assistant on the dialogue page, the second message which is replied to the first message by the digital assistant based on the book type of the first e-book on the dialogue page comprises:
displaying more content that the digital assistant replies on the dialogue page in response to a request for generating more content for the first e-book sent by the user to the digital assistant on the dialogue page, wherein the more content is generated for a keyword in the request, and the more content comprises at least one selected from the group consisting of a spin-off, a character biography, and a fan fiction related to the first e-book.

11. An electronic device, comprising:
at least a processor, and
a non-transitory memory with instructions thereon,
wherein the instructions upon execution by the processor, cause the processor to:
display a reading page of a first e-book;
display a dialogue page for dialoguing with a digital assistant in response to a trigger operation for the digital assistant on the reading page by a user; and
display a second message which is replied to the first message by the digital assistant based on a book type of the first e-book on the dialogue page in response to a first message sent by the user to the digital assistant on the dialogue page, wherein the book type of the first e-book comprises a serialized book or a finished book.

12. The electronic device according to claim 11, wherein the book type of the first e-book comprises the serialized book, and the reading page of the first e-book comprises a most recently updated content page of the first e-book, and when displaying the dialogue page for dialoguing with the digital assistant in response to the trigger operation for the digital assistant on the reading page by the user, the processor is further caused to:
display a dialogue page for dialoguing with a digital assistant corresponding to a character in the first e-book in response to a trigger operation for the digital assistant corresponding to the character on the reading page from the user, wherein the character comprises a character that has already appeared in the first e-book or a character that is expected to appear in the first e-book.

13. The electronic device according to claim 11, wherein the book type of the first e-book comprises the finished book, and the reading page comprises an ending page of the first e-book, and when displaying the dialogue page for dialoguing with the digital assistant in response to the trigger operation for the digital assistant on the reading page by the user, the processor is further caused to:
display a dialogue page for dialoguing with a digital assistant corresponding to the first e-book in response to a trigger operation for the digital assistant corresponding to the first e-book on the reading page by the user.

14. The electronic device according to claim 11, wherein the book type of the first e-book comprises the finished book; the reading page comprises a content page other than an ending page of the first e-book, and when displaying the dialogue page for dialoguing with the digital assistant in response to the trigger operation for the digital assistant on the reading page by the user, the processor is further caused to:
display a dialogue page for dialoguing with a digital assistant corresponding to a character in the first e-book in response to a trigger operation for the digital assistant corresponding to the character on the reading page by the user, wherein the character comprises a character that has already appeared before the reading page or a character that is expected to appear after the reading page.

15. The electronic device according to claim 11, wherein the book type of the first e-book comprises the serialized book, the reading page comprises a most recently updated content page of the first e-book, and when displaying, in response to the first message sent by the user to the digital assistant on the dialogue page, the second message which is replied to the first message by the digital assistant based on the book type of the first e-book on the dialogue page, the processor is further caused to:
display a possible plot development message for a character in the first e-book that the digital assistant replies on the dialogue page in response to a plot-related question sent by the user to the digital assistant on the dialogue page for the character in the first e-book.

16. The electronic device according to claim 11, wherein the book type of the first e-book comprises the finished book, the reading page comprises an ending page of the first e-book; and displaying, in response to the first message sent by the user to the digital assistant on the dialogue page, the second message which is replied to the first message by the digital assistant based on the book type of the first e-book on the dialogue page, the processor is further caused to:
display on the dialogue page at least one selected from the group consisting of a spin-off, a character biography, and a fan fiction related to the first e-book that the digital assistant replies in response to a request for more content for the first e-book sent by the user to the digital assistant on the dialogue page.

17. The electronic device according to claim 11, wherein the book type of the first e-book comprises the finished book, the reading page comprises a content page other than an ending page of the first e-book, and when displaying, in response to the first message sent by the user to the digital assistant on the dialogue page, the second message which is replied to the first message by the digital assistant based on the book type of the first e-book on the dialogue page, the processor is further caused to:
display on the dialogue page a plot development message for a character in the first e-book that the digital assistant replies in response to a plot-related question for the character in the first e-book sent by the user to the digital assistant on the dialogue page.

18. A non-transitory computer-readable storage medium storing instructions that cause at least a processor to:
display a reading page of a first e-book;
display a dialogue page for dialoguing with a digital assistant in response to a trigger operation for the digital assistant on the reading page by a user; and
display a second message which is replied to the first message by the digital assistant based on a book type of the first e-book on the dialogue page in response to a first message sent by the user to the digital assistant on the dialogue page, wherein the book type of the first e-book comprises a serialized book or a finished book.

19. The non-transitory computer-readable medium according to claim 17, wherein the book type of the first e-book comprises the serialized book, and the reading page of the first e-book comprises a most recently updated content page of the first e-book, and when displaying the dialogue page for dialoguing with the digital assistant in response to the trigger operation for the digital assistant on the reading page by the user, the processor is further caused to:
display a dialogue page for dialoguing with a digital assistant corresponding to a character in the first e-book in response to a trigger operation for the digital assistant corresponding to the character on the reading page from the user, wherein the character comprises a character that has already appeared in the first e-book or a character that is expected to appear in the first e-book.

20. The non-transitory computer-readable medium according to claim 17, wherein the book type of the first e-book comprises the finished book, and the reading page comprises an ending page of the first e-book, and when displaying the dialogue page for dialoguing with the digital assistant in response to the trigger operation for the digital assistant on the reading page by the user, the processor is further caused to:
display a dialogue page for dialoguing with a digital assistant corresponding to the first e-book in response to a trigger operation for the digital assistant corresponding to the first e-book on the reading page by the user.
